(19) United States
(12) Patent Application Publication
(10) Pub. No.: US 2026/0329574 A1
(43) Pub. Date: Oct. 22, 2026

(54) SOFTWARE MANAGEMENT METHOD FOR ELECTRONIC DEVICE, NON-TRANSITORY COMPUTER-READABLE STORAGE MEDIUM STORING SOFTWARE UPDATE PROGRAM, AND ELECTRONIC DEVICE

(71) Applicant: SEIKO EPSON CORPORATION, Tokyo (JP)

(72) Inventor: Tadao TAKAHASHI, Oita-shi (JP)

(21) Appl. No.: 19/648,027

(22) Filed: Apr. 15, 2026

(30) Foreign Application Priority Data
Apr. 16, 2025 (JP) 2025-067316

(51) Int. Cl. G06F 8/65

(52) U.S. Cl. CPC G06F 8/65

(57) ABSTRACT

According to an aspect of the present disclosure, there is provided a software management method for an electronic device including a memory that stores software of a first version and reference version information that is information concerning a version before the first version and is a reference for updatability, the software management method including, when receiving a request for update from the software of the first version to software of a second version, acquiring update information including version information indicating the second version and the software of the second version, determining whether the second version is a version indicated by the reference version information or a subsequent version, when determining that the second version is the version indicated by the reference version information or the subsequent version, permitting the update and updating the software of the first version to the software of the second version, and, when determining that the second version is not the version indicated by the reference version information or the subsequent version, not permitting the update.

The present application is based on, and claims priority from JP Application Serial Number 2025-067316, filed Apr. 16, 2025, the disclosure of which is hereby incorporated by reference herein in its entirety.

### BACKGROUND

### 1. Technical Field

The present disclosure relates to a software management method for an electronic device, a non-transitory computer-readable storage medium storing a software update program, and an electronic device.

### 2. Related Art

As disclosed in JP-A-2021-86491, there has been known a device that updates a received firmware regardless of a version of the firmware when downgrading of the firmware is set to be permitted.

JP-A-2021-86491 is an example of the related art.

However, in the device explained above, it is likely that inconvenience occurs depending on content of the update.

### SUMMARY

According to an aspect of the present disclosure, there is provided a software management method for an electronic device including a memory that stores software of a first version and reference version information that is information concerning a version before the first version and is a reference for updatability, the software management method including, when receiving a request for update from the software of the first version to software of a second version: acquiring update information including version information indicating the second version and the software of the second version; determining whether the second version is a version indicated by the reference version information or a subsequent version; when determining that the second version is the version indicated by the reference version information or the subsequent version, permitting the update and updating the software of the first version to the software of the second version; and, when determining that the second version is not the version indicated by the reference version information or the subsequent version, not permitting the update.

According to an aspect of the present disclosure, there is provided a non-transitory computer-readable storage medium storing a software update program to be executed by a processor of an electronic device that stores software of a first version and reference version information that is information concerning a version before the first version and is a reference for updatability, the software update program causing the processor to: receive a request for update from the software of the first version to software of a second version; acquire version information indicating the second version; determine whether the second version is a version indicated by the reference version information or a subsequent version; when determining that the second version is the version indicated by the reference version information or the subsequent version, permit the update; and, when determining that the second version is not the version indicated by the reference version information or the subsequent version, not permit the update.

According to an aspect of the present disclosure, there is provided an electronic device including a processor and a memory, wherein the memory stores software of a first version and reference version information that is information concerning a version before the first version and is a reference for updatability, and, when receiving a request for update from the software of the first version to software of a second version, the processor: acquires version information indicating the second version; determines whether the second version is a version indicated by the reference version information stored in the memory or a subsequent version; when determining that the second version is the version indicated by the reference version information or the subsequent version, permits the update; and, when determining that the second version is not the version indicated by the reference version information or the subsequent version, does not permit the update.

### BRIEF DESCRIPTION OF THE DRAWINGS

FIG. 1 is a block diagram illustrating a configuration of a projection device.

FIG. 2 is a flowchart illustrating a software management method for the projection device.

FIG. 3 is a table illustrating combinations of versions at the time when software of the projection device is updated.

### DESCRIPTION OF EMBODIMENTS

### 1. Configuration of a Projection Device

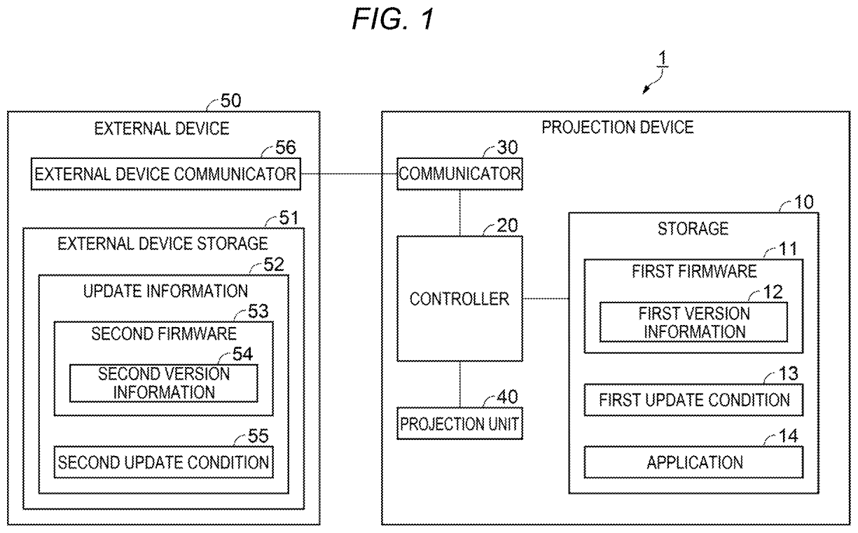

As illustrated in FIG. 1, a projection device 1, which is an electronic device, includes a storage 10, a controller 20, a communicator 30, and a projection unit 40.

The controller 20 comprehensively controls the units of the projection device 1. The controller 20 includes a central processing unit (CPU), a universal asynchronous receiver transmitter (UART) that manages input and output, and a field programmable gate array (FPGA) and a programmable logic device (PLD), which are logic circuits. The controller 20 is also referred to as a processor. The CPU of the controller 20 is sometimes referred to as, in particular, a processor.

The storage 10, which is a memory, includes a flash read only memory (ROM) and a hard disk drive (HDD), which are rewritable nonvolatile memories, and a random access memory (RAM), which is a volatile memory. The nonvolatile memory of the storage 10 may include a solid state drive (SSD).

In the storage 10, first firmware 11 including first version information 12 and a first update condition 13 are stored. The first firmware 11 may include the first update condition 13.

The first version information 12 included in the first firmware 11 is information indicating a first version that is a version of the first firmware 11. The first firmware 11 is software of the first version. Hereinafter, the first firmware 11, second firmware 53 explained below, and the like are collectively simply referred to as firmware.

The controller 20 can read the first firmware 11 stored in the nonvolatile memory of the storage 10, execute the first firmware 11 using the volatile memory as a work area, and control the units of the projection device 1.

Further, in the storage 10, an application 14, which is an application program capable of causing the controller 20 to update the first firmware 11, is stored. The application 14 is also referred to as software update program.

The controller 20 can read the application 14 stored in the nonvolatile memory of the storage 10, execute the application 14 using the volatile memory as a work area, and update the first firmware 11 to the second firmware 53 as explained below.

The projection unit 40 includes a light source, a liquid crystal light valve, and a projection lens (all of which are not illustrated). The controller 20 can read the first firmware 11 from the storage 10 and execute the first firmware 11, control the units of the projection unit 40, and project a projection image based on acquired image data.

Specifically, the units operate as follows under the control by the controller 20. The light source emits light to the liquid crystal light valve. The liquid crystal light valve modulates, based on the image data, light emitted from the light source. The liquid crystal light valve can generate color component images by modulating the light. The projection lens combines the color component images formed by the liquid crystal light valve and projects a combined image as a projection image. Projection is also referred to as image projection, video projection, or screen projection.

The controller 20 can acquire image data from the storage 10 or an external device 50 explained below.

The communicator 30 includes a circuit capable of communicating by radio or wire. The communicator 30 includes an antenna in the case of the communication by radio and includes a connector in the case of the communication by wire. The communicator 30 is capable of communicating with an external device 50.

The external device 50 is, for example, a computer, a storage medium such as a universal serial bus (USB) memory, or a device capable of reading information from a storage medium, such as a digital versatile disc (DVD) drive.

The external device 50 includes an external device storage 51 that stores update information 52 and the like and an external device communicator 56. When the external device 50 is the computer or the like, the external device 50 may include a controller such as the controller 20 of the projection device 1 explained above. The external device communicator 56 is capable of communicating with the communicator 30 of the projection device 1. For example, when the external device 50 is the USB memory, the external device communicator 56 of the external device 50 and the communicator 30 of the projection device 1 are capable of communicating with each other via a USB.

The projection device 1 may include an operation panel (not illustrated). A user can operate the operation panel to perform various settings and various instructions on the projection device 1. The operation panel may be a touch panel display including an input unit and an output unit.

### 2. Software Management Method for the Projection Device

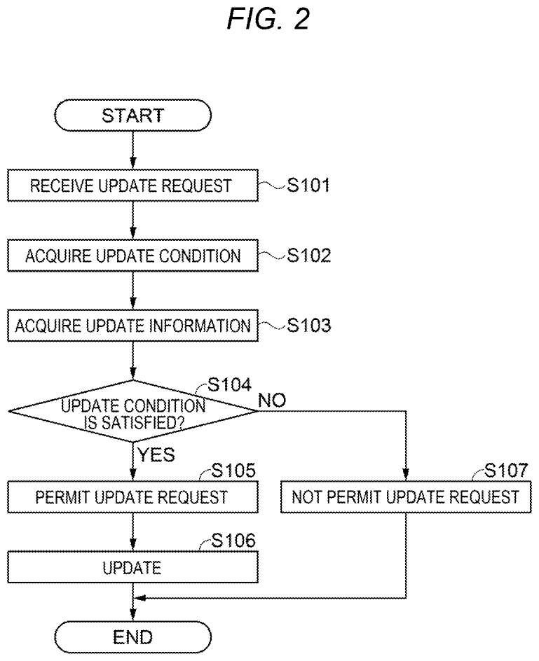

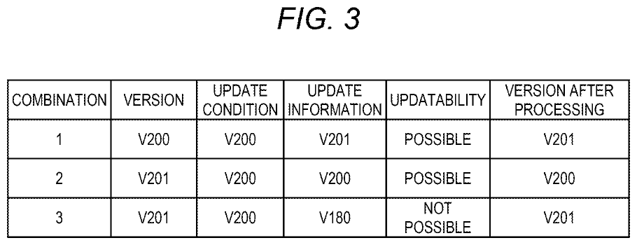

A software management method for updating firmware of the projection device 1 is explained with reference to FIGS. 2 and 3.

The software management method for the projection device 1 explained below is performed by the controller 20 of the projection device 1 reading and executing the application 14 stored in the storage 10. In the following explanation of the units of the projection device 1, the name of the projection device 1 is omitted and only the names of the units are referred to.

As illustrated in FIG. 2, the controller 20 reads the application 14 from the storage 10 and executes the application 14 and starts processing relating to the software management method. The following processing by the controller 20 is also referred to as update processing.

The controller 20 receives, with the communicator 30, a request for update to the second firmware 53 from the external device 50 such as the computer (S101). When the external device 50 is the storage medium such as the USB memory, the controller 20 may receive the update request when the storage medium is coupled to the communicator 30. The controller 20 may receive operation of the update request by the user through the operation panel.

The update information 52 stored in the external device storage 51 of the external device 50 includes the second firmware 53 and second update condition 55. Second version information 54 included in the second firmware 53 is information indicating a second version that is a version of second firmware 53. The second firmware 53 is software of the second version. The second firmware 53 may include the second update condition 55.

The external device 50 transmits the update information 52 to the projection device 1 via the external device communicator 56 together with or after the request for update to the second firmware 53.

At this time, the external device 50 may transmit at least the second version information 54 included in the update information 52 rather than all information included in the update information 52. In this case, when the projection device 1 permits the update request as explained below, the external device 50 may transmit the second firmware 53 included in the update information 52. The external device 50 can transmit the second update condition 55 in the same manner.

The controller 20 reads and acquires the first update condition 13 from the storage 10 (S102). The controller 20 receives and acquires, with the communicator 30, the update information 52 from the external device 50 (S103).

The controller 20 sometimes receives, from the external device 50, at least the second version information 54 included in the update information 52 rather than all the information included in the update information 52. In this case, when permitting the update request as explained below, the controller 20 may transmit, to the external device 50, information indicating that the update request has been permitted.

The external device 50 transmits the second firmware 53 included in the update information 52 in response to the permission of the update request from the projection device 1. The controller 20 can receive and acquire the second firmware 53 with the communicator 30. The controller 20 can acquire the second update condition 55 in the same manner.

Here, a relationship between the first update condition 13 of the projection device 1 and the update information 52 of the external device 50 is explained in detail with reference to FIG. 3. In FIG. 3 and the following explanation referring to FIG. 3, for example, “V200” indicates a version and more specifically indicates a version number. As a value indicated by the version number is smaller, the version is older.

In FIG. 3, “version” is the first version indicated by the first version information 12 of the first firmware 11. “Update condition” indicates a first reference version included in a first update condition 13 explained below. “Update information” is the second version indicated by the second version information 54 included in the second firmware 53.

The first firmware 11, which is the software of the first version, is stored in the current storage 10 before update.

The first update condition 13 is information for the controller 20 to determine updatability from the first firmware 11 to the second firmware 53. The first update condition 13 includes first reference version information that is a reference for the controller 20 to determine updatability. The first reference version information is information indicating the first reference version and is set as information concerning a version before the first version.

In general, software such as the first firmware 11 is updated to be upgraded, for example, added with a function. However, for example, when a defect is found, the updated software is sometimes temporarily downgraded and returned to old software without the defect. Thereafter, when new software in which the defect is resolved is prepared, the old software is updated to the new software.

However, when the software is downgraded, depending on a version of the old software, inconvenience sometimes occurs concerning use, a service, and the like.

For example, it is assumed that, from a predetermined version of the first firmware 11, the projection device 1 has a predetermined function supporting a service such as subscription or rental.

In this case, if the first firmware 11 is downgraded to a version older than the predetermined version, since the projection device 1 does not have the predetermined function, the service such as the subscription cannot be received.

When such a service is received, the projection device 1 is connected to a server (not illustrated) that is managed by a service providing company or the like and provides the service.

The first update condition 13 is set in the storage 10 such that the service can be continuously received. As explained above, the first update condition 13 includes information received from the external device 50 and serving as a reference for the controller 20 to determine whether update to the second firmware 53 is possible. Specifically, the first update condition 13 includes the first reference version indicated by the first reference version information.

The first reference version is set as a version before the first version including the first version. Further, as explained below, the first reference version can be set as, for example, a version supporting a predetermined function such as subscription or a subsequent version in order to restrict update. That is, the first reference version can be set as a version before the first version, the version supporting the predetermined function, or a subsequent version.

As illustrated in FIG. 3, “V200”, which is the first reference version indicated by the first reference version information, is set as the first update condition 13. As explained below, “V200” is a version before the first version, the version supporting the predetermined function, or a subsequent version.

It is assumed that the first update condition 13 is stored in the storage 10 when the current first firmware 11 is stored.

The controller 20 compares the first reference version indicated by the first reference version information of the first update condition 13 acquired from the storage 10 and the second version indicated by the second version information 54 of the second firmware 53 acquired from the external device 50 and determines whether the second version is the first reference version or a subsequent version.

That is, the controller 20 determines whether the update information 52 satisfies the first update condition 13 (S104).

When determining that the second version is the first reference version or a subsequent version and determining that the update information 52 satisfies the first update condition 13 (S104: YES), the controller 20 permits the update request received from the external device 50 (S105) and updates the first firmware 11 to the second firmware 53 (S106). When permitting the update request, the controller 20 may transmit, to the external device 50, information indicating that the update request has been permitted.

The controller 20 can acquire the second firmware 53 including the second version information 54 and the second update condition 55, store the second firmware 53 and the second update condition 55 in the storage 10, and update the second firmware 53 and the second update condition 55.

On the other hand, when determining that the second version is older than the first reference version and is not the first reference version or a subsequent version and determining that the update information 52 does not satisfy the first update condition 13 (S104: NO), the controller 20 does not permit the received update request (S107) and ends the processing without updating the first firmware 11 to the second firmware 53. At this time, the controller 20 may transmit, to the external device 50, information indicating that the update request is not permitted.

Processing of the controller 20 for a plurality of combinations of the first update condition 13 and the update information 52 is explained with reference to FIG. 3. In an example illustrated in FIG. 3, the first reference version, which is the first update condition 13, is set as “V200” in all the combinations.

In a “combination 1”, the second version of the second firmware 53 included in the update information 52 is “V201”. The controller 20 can determine that “V201”, which is the second version, is “V200”, which is the first reference version, or a subsequent version and the update information 52 satisfies the first update condition 13, permit the update request, and update the first firmware 11 as updatable.

After the update, the second firmware 53 of “V201” is stored in the storage 10. It is assumed that the first firmware 11 of “V200” was stored in the storage 10 before the update.

In this case, the first firmware 11 of “V200” is upgraded to the second firmware 53 of new “V201”. For example, the controller 20 can update the first firmware 11 to the second firmware 53 of “V201” added with a function.

In a “combination 2”, the second version of the second firmware 53 included in the update information 52 is “V200”. The controller 20 can determine that “V200”, which is the second version, is the same version as “V200”, which is the first reference version, or a subsequent version and the update information 52 satisfies the first update condition 13, permit the update request, and update the first firmware 11 as updatable.

After the update, the second firmware 53 of “V200” is stored in the storage 10. It is assumed that the first firmware 11 of “V201” was stored in the storage 10 before the update.

In this case, the first firmware 11 of “V201” is downgraded to the second firmware 53 of old “V200”. For example, when there is a defect in the first firmware 11 of “V201”, the controller 20 can temporarily return the first firmware 11 to the second firmware 53 of the old version “V200” without this defect.

In a “combination 3”, the second version of the second firmware 53 included in the update information 52 is “V180”. “V180”, which is the second version, is older than “V200”, which is the first reference version. The controller 20 determines that “V180”, which is the second version, is not “V200”, which is the first reference version, or a subsequent version and the update information 52 does not satisfy the first update condition 13, does not permit the update request, and does not update the first firmware 11 as un-updatable.

After the processing of the “combination 3”, the first firmware 11 of “V201” is held in the storage 10 without being updated in the same manner as before the processing.

For example, it is assumed that, from “V200” and a subsequent version including “V200”, the first firmware 11 supports a predetermined function such as subscription.

In the case of the “combination 1”, the controller 20 can upgrade the first firmware 11 of “V200” to the second firmware 53 of “V201”, both of which are firmware supporting the predetermined function.

In the case of the “combination 2” as well, the controller 20 can downgrade the first firmware 11 of “V201” to the second firmware 53 of “V200”, both of which are firmware supporting the predetermined function.

On the other hand, in the case of the “combination 3”, the controller 20 can restrict the first firmware 11 of “V201” supporting the predetermined function not to be downgraded to the second firmware 53 of “V180” not supporting the predetermined function.

The controller 20 can determine possibility of the downgrading based on “V200”, which is the first reference version supporting the predetermined function, and prevent a service such as subscription relating to the predetermined function from not being able to be received.

As explained above, the first reference version can be set as a version before the first version, the version supporting the predetermined function, or a subsequent version. The projection device 1 can continuously support the predetermined function.

Here, content of the first reference version indicated by the first reference version information, the version being the first reference version for the controller 20 to determine updatability, is explained more in detail.

In the case of the “combination 3”, when there is a prospect that the defect of the first firmware 11 is to be resolved, the controller 20 may temporarily set the first reference version to be one version older than “V200” and downgrade the first firmware 11 to firmware one version older than “V200”. Although the predetermined function does not temporarily function, the controller 20 is capable of resolving the defect and can immediately upgrade the first firmware 11 to support the predetermined function as well.

When a new version and an old version are present in the predetermined function, the first reference version may be determined to be based on the new version. When there is no problem even if the predetermined function is returned to the old version, the first reference version may be determined to be based on the old version.

When firmware has two or more functions of attention and versions of the functions are different, the first reference version may be determined according to the latest version for which update restriction is stricter. For example, when the functions of attention are a function A and a function B and the function A is “V205” and the function B is “V207”, the first reference version is determined as “V207”, which is the latest version.

As described above, when there are the two or more functions of attention, the controller 20 can determine updatability based on the version for which restriction is stricter.

The version indicated by the first reference version information can include a third version. Hereinafter, firmware that is software of the third version is referred to as third firmware.

The third firmware can include at least one of a first function, a second function, or a setting item explained below.

For example, it is assumed that the first function is a function added from the time of the third version. In the example explained above, the first function is the predetermined function such as subscription. In this case, first, the third version is “V200” supporting the predetermined function. The controller 20 can determine updatability according to the third version and restrict the third version not to be downgraded to an old version not supporting the predetermined function.

For example, it is assumed that, in the second function, allocation of a storage area of the storage 10 is different between the third version and a version older than the third version.

Specifically, the second function is a function relating to point correction, which is an example of geometric correction. The point correction is, by adjusting the positions of intersections obtained by dividing an image projected by the projection device 1 into a grid pattern, correcting distortion of the image. A configuration of image data is different and the allocation of the storage area of the storage 10 is different depending on the number of intersections to be corrected.

For example, in the third version, it is assumed that the number of intersections to be subjected to the point correction is 30. On the other hand, in a version older than the third version, it is assumed that the number of intersections to be corrected is 20. If the third version is downgraded to the old version, since the allocation of the storage area of the storage 10 changes, it is likely that a result of the point correction unintended by the user is obtained and a projection image unintended by the user is obtained.

The controller 20 can determine updatability according to the third version and can restrict the third version not to be downgraded to the old version in which the allocation of the storage area of the storage 10 is different.

For example, it is assumed that, in the setting item, a definition of parameters is different between the third version and a version older than the third version and the user can change an item.

Specific examples of the setting item include at least any one of over-scan setting, color matching adjustment, contrast adjustment, color density adjustment, and effect setting. The definition of the parameters being different means that, for example, the number of these items increases or decreases and increments of setting values or adjustment values of these items are different.

If the third version is downgraded to the old version, it is likely that a projection image unintended by the user is obtained. The controller 20 can determine updatability according to the third version and restrict the third version not to be downgraded to the old version in which the definitions of the setting item parameters are different.

As explained above, the controller 20 can determine updatability according to the third version including at least one of the first function, the second function, and the setting item of attention.

The third firmware explained above can include setting the first function to be enabled or disabled according to the first function and control by administrator authority.

When the first function is enabled, the version indicated by the first reference version information is set as the third version. On the other hand, when the first function is disabled, the version indicated by the first reference version information is set as a fourth version older than the third version.

In the example explained above, the first function, which is the predetermined function such as subscription, is a function added from the time of the third version.

When the first function is enabled, the first reference version is the third version. The controller 20 can determine updatability according to the third version and restrict the third version not to be downgraded to the old version not supporting the first function. The projection device 1 can continuously support the first function.

On the other hand, when the first function is disabled, the first reference version is the fourth version. The controller 20 can determine updatability according to the fourth version and downgrade the fourth version to the old version not supporting the first function.

In this case, the first function is disabled and the controller 20 does not support the first function from the time before the update. Since the user does not use the first function from the time before the update, there is no problem even if the projection device 1 downgrades the fourth version to the old version not supporting the first function.

Since the controller 20 sets the first function to be enabled or disabled according to the control by the administrator authority, the controller 20 can disable the user to set the first function.

Here, update from the first update condition 13 to the second update condition 55, which is the next update condition, is explained. The controller 20 can also update the first update condition 13 stored in the storage 10 to the received second update condition 55 when or after updating from the first firmware 11 to the second firmware 53.

A second reference version indicated by second reference version information included in the second update condition 55 can be a version for the controller 20 to determine updatability of the next firmware.

The second reference version can be set to a version newer than the first reference version according to occurrence or resolution of a defect of firmware and occurrence or resolution of a defect concerning use of the projection device 1 and service reception.

That is, the update information 52 includes the second update condition 55 that is the next update condition. When permitting the update, the controller 20 can update, based on the second update condition 55, the reference version information, which is the reference for updatability of the next firmware, from the first reference version information to the second reference version information.

When updating the reference version information, the controller 20 can update the reference version information when the second version is a version newer than the first version. At this time, when the second version is a version older than the first version, the controller 20 can choose not to update the reference version information.

### Summary of the Present Disclosure

A summary of the present disclosure is appended below.

### Appendix 1

A software management method for an electronic device including a memory that stores software of a first version and reference version information that is information concerning a version before the first version and is a reference for updatability, the software management method including, when receiving a request for update from the software of the first version to software of a second version: acquiring update information including version information indicating the second version and the software of the second version; determining whether the second version is a version indicated by the reference version information or a subsequent version; when determining that the second version is the version indicated by the reference version information or the subsequent version, permitting the update and updating the software of the first version to the software of the second version; and, when determining that the second version is not the version indicated by the reference version information or the subsequent version, not permitting the update.

Accordingly, since the software management method for the electronic device permits the update based on the version indicated by the reference version information, it is possible to prevent update that causes inconvenience in the electronic device.

### Appendix 2

The software management method for the electronic device described in Appendix 1, wherein the version indicated by the reference version information includes a third version, and software of the third version includes at least one of a first function added from a time of the third version, a second function in which allocation of a storage area of the memory is different between the third version and a version older than the third version, and a setting item in which a definition of a parameter is different between the third version and the version older than the third version and that can be changed by a user.

Accordingly, the software management method for the electronic device can determine the updatability according to the third version including at least one of the first function, the second function, and the setting item of attention.

### Appendix 3

The software management method for the electronic device described in Appendix 2, wherein software of the third version includes setting the first function to be enabled or disabled according to the first function and control by administrator authority, the version indicated by the reference version information is the third version when the first function is enabled, and the version indicated by the reference version information is a fourth version older than the third version when the first function is disabled.

Accordingly, the software management method for the electronic device can determine the permission of the update according to the third version when the first function is enabled and determine the permission of the update according to the fourth version when the first function is disabled.

### Appendix 4

The software management method for the electronic device described in any one of Appendices 1 to 3, wherein the update information includes a next update condition, and, when the update is permitted, the reference version information is updated based on the next update condition.

Accordingly, the software management method for the electronic device can update the reference version information when the update is permitted.

### Appendix 5

The software management method for the electronic device described in Appendix 4, wherein the updating the reference version information is updating the reference version information when the second version is a version newer than the first version, and the reference version information is not updated when the second version is a version older than the first version.

Accordingly, the software management method for the electronic device can update the reference version information when the second version is a version newer than the first version and can choose not to update the reference version information when the second version is a version older than the first version.

### Appendix 6

A non-transitory computer-readable storage medium storing a software update program to be executed by a processor of an electronic device that stores software of a first version and reference version information that is information concerning a version before the first version and is a reference for updatability, the software update program causing the processor to: receive a request for update from the software of the first version to software of a second version; acquire version information indicating the second version; determine whether the second version is a version indicated by the reference version information or a subsequent version; when determining that the second version is the version indicated by the reference version information or the subsequent version, permit the update; and, when determining that the second version is not the version indicated by the reference version information or the subsequent version, not permit the update.

Accordingly, since the software update program causes the processor of the electronic device to permit the update based on the version indicated by the reference version information, it is possible to prevent update that causes inconvenience in the electronic device.

### Appendix 7

An electronic device including a processor and a memory, wherein the memory stores software of a first version and reference version information that is information concerning a version before the first version and is a reference for updatability, and the processor: when receiving a request for update from the software of the first version to software of a second version, acquires version information indicating the second version; determines whether the second version is a version indicated by the reference version information stored in the memory or a subsequent version; when determining that the second version is the version indicated by the reference version information or the subsequent version, permits the update; and, when determining that the second version is not the version indicated by the reference version information or the subsequent version, does not permit the update.

Accordingly, since the electronic device permits the update based on the version indicated by the reference version information, it is possible to prevent update that causes inconvenience in the electronic device.

While the embodiment is explained in detail above with reference to the drawings, specific configurations are not limited to the embodiment and may be, for example, changed, replaced, or deleted without departing from the gist of the present disclosure.

For example, although the projection device 1 is exemplified as the electronic device in the above explanation, the electronic device may be an image forming device including a recording head.

Programs for implementing functions of any components in the devices explained above may be recorded in a computer-readable storage medium including a processor and the programs may be read and executed by a computer system including an electronic device. The “computer-readable storage medium” includes a portable medium such as a flexible disc, a magneto-optical disc, a ROM, or a CD (compact disk)-ROM and a storage device such as a hard disk incorporated in the computer system. Further, the “computer-readable storage medium” also includes a medium that holds the programs for a fixed time, such as a volatile memory inside the computer system serving as a server or a client when the programs are transmitted via a network such as the Internet or a communication line such as a telephone line.

The programs may be transmitted from a computer system in which the programs are stored in a storage device or the like to another computer system via a transmission medium or by a transmission wave in the transmission medium. Here, the “transmission medium” for transmitting the programs refers to a medium having a function of transmitting information like a network such as the Internet or a communication line such as a telephone line.

The programs explained above may be programs for implementing some of the functions explained above. Further, the programs may be so-called differential files or differential programs that can implement the functions explained above in combination with programs already recorded in the computer system.

What is claimed is:

1. A software management method for an electronic device including a memory that stores software of a first version and reference version information that is information concerning a version before the first version and is a reference for updatability, the software management method comprising,
when receiving a request for update from the software of the first version to software of a second version:
acquiring update information including version information indicating the second version and the software of the second version;
determining whether the second version is a version indicated by the reference version information or a subsequent version;
when determining that the second version is the version indicated by the reference version information or the subsequent version, permitting the update and updating the software of the first version to the software of the second version; and
when determining that the second version is not the version indicated by the reference version information or the subsequent version, not permitting the update.

2. The software management method for the electronic device according to claim 1, wherein
the version indicated by the reference version information includes a third version, and
software of the third version includes at least one of a first function added from a time of the third version, a second function in which allocation of a storage area of the memory is different between the third version and a version older than the third version, and a setting item in which a definition of a parameter is different between the third version and the version older than the third version and that can be changed by a user.

3. The software management method for the electronic device according to claim 2, wherein
software of the third version includes setting the first function to be enabled or disabled according to the first function and control by administrator authority,
the version indicated by the reference version information is the third version when the first function is enabled, and
the version indicated by the reference version information is a fourth version older than the third version when the first function is disabled.

4. The software management method for the electronic device according to claim 1, wherein
the update information includes a next update condition, and
when the update is permitted, the reference version information is updated based on the next update condition.

5. The software management method for the electronic device according to claim 4, wherein
the updating the reference version information is updating the reference version information when the second version is a version newer than the first version, and
the reference version information is not updated when the second version is a version older than the first version.

6. A non-transitory computer-readable storage medium storing a software update program to be executed by a processor of an electronic device that stores software of a first version and reference version information that is information concerning a version before the first version and is a reference for updatability, the software update program causing the processor to:
receive a request for update from the software of the first version to software of a second version;
acquire version information indicating the second version;
determine whether the second version is a version indicated by the reference version information or a subsequent version;
when determining that the second version is the version indicated by the reference version information or the subsequent version, permit the update; and
when determining that the second version is not the version indicated by the reference version information or the subsequent version, not permit the update.

7. An electronic device comprising a processor and a memory, wherein
the memory stores software of a first version and reference version information that is information concerning a version before the first version and is a reference for updatability, and
the processor:
when receiving a request for update from the software of the first version to software of a second version, acquires version information indicating the second version;
determines whether the second version is a version indicated by the reference version information stored in the memory or a subsequent version;
when determining that the second version is the version indicated by the reference version information or the subsequent version, permits the update; and
when determining that the second version is not the version indicated by the reference version information or the subsequent version, does not permit the update.
